(19) United States
(12) Patent Application Publication
(10) Pub. No.: US 2021/0262821 A1
(43) Pub. Date: Aug. 26, 2021

(54) INFORMATION PROVIDING SYSTEM

(71) Applicant: HONDA MOTOR CO., LTD., Tokyo (JP)

(72) Inventors: Tomoaki HAGIHARA, Wako-shi (JP); Satoshi KAMATANI, Wako-shi (JP); Mitsuki KIMURA, Wako-shi (JP); Yuiko KUMAGAI, Wako-shi (JP); Kazuya WATANABE, Wako-shi (JP)

(21) Appl. No.: 17/182,680

(22) Filed: Feb. 23, 2021

(30) Foreign Application Priority Data
Feb. 26, 2020 (JP) 2020-030256

(51) Int. Cl. G01C 21/36; G06F 16/9537; G06F 16/9538

(52) U.S. Cl. CPC G01C 21/3679; G06F 16/9538; G06F 16/9537

(57) ABSTRACT

From among pieces of referral information recorded in a points of interest (POI) information recording unit concerning POI extracted in accordance with a specific term which is set based on an input from a user, the referral information that includes related terms of the specific term is used to create referral text of the extracted POI.

### CROSS-REFERENCE TO RELATED APPLICATION

This application is based upon and claims the benefit of priority from Japanese Patent Application No. 2020-030256 filed on Feb. 26, 2020, the contents of which are incorporated herein by reference.

### BACKGROUND OF THE INVENTION

### Field of the Invention

The present invention relates to an information providing system that provides information about points of interest (hereinafter referred to as POI or spots) to a user in accordance with a position of the user.

### Description of the Related Art

For example, in Japanese Laid-Open Patent Publication No. 10-013961 (hereinafter referred to as JPH10-013961A), a mobile communication system is disclosed in which, by a mobile terminal transmitting information of its own position to an information center, the mobile terminal is capable of using facility information or services of facilities related to position information which is stored in a storage unit of the information center (see paragraphs [0019] and [0119] of JPH10-013961A).

### SUMMARY OF THE INVENTION

The mobile communication system disclosed in JPH10-013961A provides the facility information and the like in accordance with the position of the user of the mobile terminal.

However, a problem arises in that it is not possible to provide appropriate referral information for points of interest (POI) in accordance with a specific term based on an input from the user.

The present invention has been devised taking into consideration the aforementioned problem, and has the object of providing an information providing system, which is capable of providing to a user appropriate referral information of points of interest (POI) in accordance with a specific term based on an input from the user.

One aspect of the present invention is characterized by an information providing system comprising a points of interest (POI) information recording unit configured to record identification information of POI in association with referral information of the POI, and a referral text creation unit configured to create referral text concerning the POI by using the referral information associated with the POI, the information providing system further comprising a term recording unit configured to record a specific term, and related terms having a predetermined logical relationship with the specific term, and a POI extraction unit configured to extract at least one of the POI from the POI information recording unit, in accordance with the specific term that is set based on an input from a user, wherein the referral text creation unit creates the referral text of the extracted POI using, from among pieces of the referral information recorded in the POI information recording unit concerning the extracted POI, the referral information that includes the related terms of the specific term that is set based on the input.

In accordance with the present invention, from among the pieces of the referral information recorded in the POI information recording unit concerning the POI extracted in accordance with the specific term which is set based on an input from the user, referral text of the extracted POI is created using the referral information that includes related terms of the specific term. Therefore, it is possible to provide appropriate POI referral information in accordance with the specific term based on the input from the user.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing the configuration of a system including a server which serves as an information providing system according to an embodiment of the present invention;

FIG. 2 is a table in which there is shown an example of the content recorded in a POI information recording unit;

FIG. 3 is a tree diagram in which there is shown an example of the content recorded in a term recording unit; and

FIG. 4 is a flowchart provided to describe operations of the system including the server serving as the information providing system according to the embodiment.

### DETAILED DESCRIPTION OF THE PREFERRED EMBODIMENTS

An embodiment of an information providing system according to the present invention will be presented and described in detail below with reference to the accompanying drawings.

### Embodiment

### [Configuration]

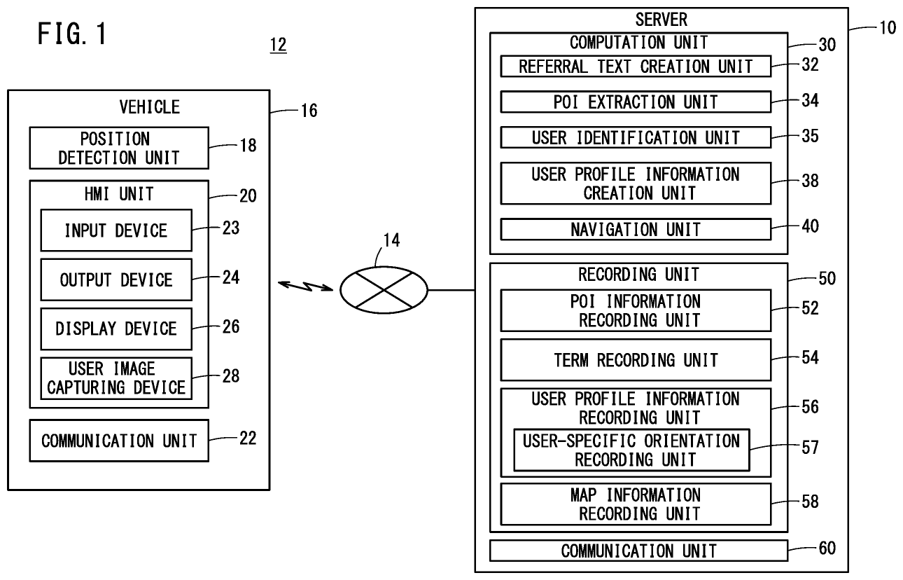

FIG. 1 is a diagram showing the configuration of a system 12 including a server 10 serving as an information providing system according to the embodiment.

In addition to the server 10, the system 12 is equipped with a vehicle 16 which is used by a user and which carries out communications via a network 14 such as a public line or the like.

The vehicle 16 includes a position detection unit 18, a human-machine interface unit (HMI unit) 20 that governs or controls an interface with the user, and a communication unit 22.

The HMI unit 20 includes an input device (a voice input device or a manual input device) 23 such as a microphone or a touch panel or the like, an output device 24 such as a speaker, a display device 26 that can serve in a dual manner as an input/output device, and a user image capturing device 28 which is made up of cameras.

The user image capturing device 28, for example, is a plurality of user monitor cameras which are mounted in the vehicle compartment interior, and which constantly capture images of all of the occupants in the vehicle by the plurality of cameras, including the head (face) of a user such as the driver. The user image capturing device 28 creates user captured image information of all of the vehicle occupants.

The position detection unit 18, for example, is a navigation device, and detects the position of the vehicle 16. As is well known, on the basis of recorded map information, the navigation device searches, by way of a route searching unit, for a recommended route to a destination set by the HMI unit 20 in accordance with an input from the user, and guides the user to the destination by guiding the vehicle 16 to the destination according to the recommended route that was searched for.

The communication unit 22 transmits, to the server 10 via the network 14, the position information of the vehicle 16 that is detected by the position detection unit 18, the input information obtained by the input device 23 of the HMI unit 20, and the user captured image information obtained by the user image capturing device 28. Further, the communication unit 22 receives the information transmitted from the server 10, for example, route information to a specified POI, and outputs the information to the output device 24 or on the display device 26 of the HMI unit 20.

Moreover, according to the present embodiment, a navigation unit 40 of the server 10 obtains, through the communication unit 22, the network 14, and a communication unit 60, the destination that was set by the HMI unit 20 in accordance with the input from the user, searches for the recommended route to the destination (including the specified POI) based on the map information recorded in a map information recording unit 58, and sets the set route, which is the result of the route search, in the position detection unit 18 of the vehicle 16 through the communication unit 60, the network 14, and the communication unit 22. In this case, the vehicle 16 in which the user is riding is guided in accordance with the set route that is the result of the route search, and the user can be guided to the destination, or stated otherwise, route guidance can be performed.

The server 10 is a computer, and includes a computation unit 30, a recording unit 50, and the communication unit 60.

The computation unit 30 is constituted by a processor equipped with, for example, a CPU or the like. The computation unit 30 realizes various functions by executing programs recorded in the recording unit 50. In this instance, the computation unit 30 functions as a referral text creation unit 32, a POI extraction unit 34, a user identification unit 35, a user profile information creation unit 38, and the navigation unit 40.

In addition to the programs, the recording unit 50 includes a POI information recording unit 52, a term recording unit 54, a user profile information recording unit 56, and the map information recording unit 58. The user profile information recording unit 56 includes a user-specific orientation recording unit 57.

The POI information recording unit 52 records the POI identification information and the POI referral information in association with each other.

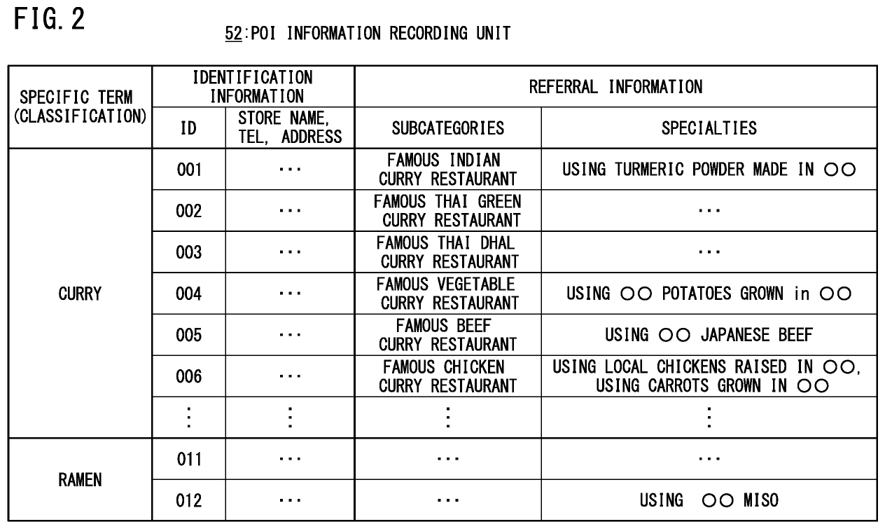

FIG. 2 is a table in which there is shown an example of the content recorded in the POI information recording unit 52.

The POI information recording unit 52 includes as items thereof specific terms {classifications (curry, ramen, etc.)}, identification information {an ID, a store name, a telephone number (TEL), an address}, and referral information. The referral information may be recorded for each of a plurality of types of referral information, such as subcategories and specialties.

The term recording unit 54 records the specific terms and related terms (superordinate concepts, subordinate concepts/subclasses, constituent ingredients, etc.) having a predetermined logical relationship (in the present example, a systematic tree structure) with the specific terms.

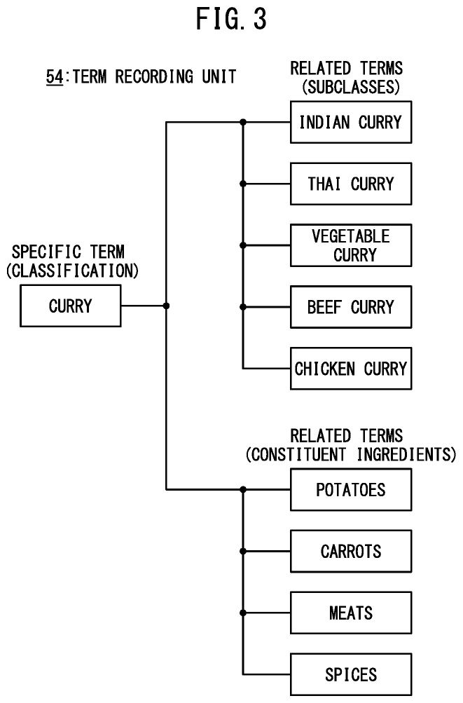

FIG. 3 shows an example of the recorded content of the term recording unit 54, in which the related terms are defined as subclasses and constituent ingredients. The term recording unit 54 may record, as the related terms, terms defining superordinate concepts, subordinate concepts of the superordinate concepts, subordinate concepts/subclasses, and constituent ingredients of the specific terms.

The recorded content of the term recording unit 54 is made up from the specific terms (classifications, for example, curry) and the related terms (subclasses, constituent ingredients) having a predetermined logical relationship with the specific terms.

Among the related terms, the subclasses are Indian curry, Thai curry, etc., and among the related terms, the constituent ingredients thereof are potatoes, carrots, meats, spices, etc.

The user profile information creation unit 38 extracts a user profile based on user-specific behaviors (behavior history) of the vehicle 16, which are identified by the user identification unit 35, creates user profile (user-specific profile) information, and records the user profile information in the user profile information recording unit 56.

The user-specific orientation recording unit 57 of the user profile information recording unit 56 has recorded therein an orientation of the user for each of the users that are identified in advance. The orientation of the user includes the preferences of the user. In the present embodiment, the orientation of the user is established in the order of cumulative values of the specific terms (or related terms of the specific terms) which are set by the user profile information creation unit 38 based on inputs from the user. More specifically, in the user-specific orientation recording unit 57, an orientation of the user is recorded and stored in a frequency distribution for each of the users.

The map information recording unit 58 includes route calculation information used by the navigation unit 40 to calculate the set route (recommended route), and route guidance information, road information representing the shapes of roads, and furthermore, background information representing map shapes other than roads, such as coastlines, rivers, railways, and buildings, etc., along with the POI information and the like, which are used for guiding the user's own vehicle 16 to a destination according to the recommended route including the names of intersections, road names, and the like.

The referral text creation unit 32 creates referral text concerning specific POI.

The POI extraction unit 34 extracts from the POI information recording unit 52 at least one of the POI to be recommended to the user, in accordance with the specific term (classification) that was set based on the input from the user of the vehicle 16.

### [Operations]

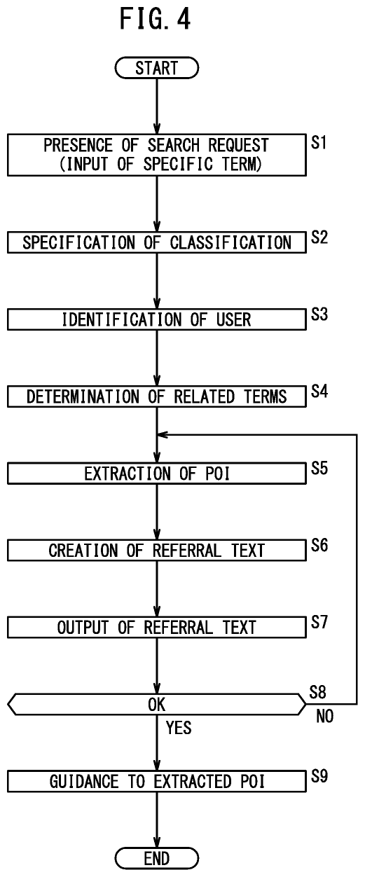

Next, on the basis of the flowchart shown in FIG. 4, a description will be given in detail concerning operations of the system 12 including the server 10 in the form of the information providing system according to the embodiment, which is configured basically in the manner described above. Unless otherwise specified, it will be assumed that the computation unit 30 of the server 10 executes the processes according to the flowchart. However, since it is complicated to refer to this feature each time that it happens, such a feature will be referred to only as necessary.

In step S1, the POI extraction unit 34 performs a specific term (classification) specifying process in step S2, which is triggered by the fact that a user search request that was input by the input device 23 of the vehicle 16 (in this instance, a search request made by voice, saying “search for a curry restaurant”) is received by the communication unit 60 via the communication unit 22.

In step S2, based on the voice input of “search for a curry restaurant,” the POI extraction unit 34 specifies the specific term (classification) as “curry” by referring to the specific term (classification) in the POI information recording unit 52.

Next, in step S3, the user identification unit 35 compares the image (face image) captured by the user image capturing device 28 with the face images recorded in the user profile information recording unit 56 (user-specific orientation recording unit 57), and thereby identifies the user. The user may also be identified by way of voice recognition.

In step S4, for the specific term “curry”, the term recording unit 54 is referred to, and related terms having a predetermined logical relationship with the term “curry (specific term)” are determined. More specifically, the terms “Indian curry,” “Thai curry,” “vegetable curry,” “beef curry,” and “chicken curry,” which have a predetermined logical relationship (subclasses) with the term “curry (specific term), and the terms “potatoes,” “carrots,” “meats,” and “spices,” which have a predetermined logical relationship (constituent ingredients) with the term “curry (specific term),” are determined respectively as related terms.

Moreover, the user-specific orientation recording unit 57 may be referred to, and predetermined terms may be preferentially determined as the related terms based on the orientation of the user.

Further, the related terms may be determined by referring to the user-specific orientation recording unit 57, and using a predetermined logical relationship with priority over the other logical relationships based on the orientation of the user. For example, the logical relationship preferred by the user may be recorded in the user-specific orientation recording unit 57 based on a usage history of the referral text creation unit 32 (for example, the fact that more related terms which are logically related as “subclasses” have been used), and based on the recorded relationship, the logical relationship “subclasses” may be used as the predetermined logical relationship preferred by the user with priority over the other logical relationships (for example, constituent ingredients) to thereby determine the related terms.

In step S5, in accordance with the specific term “curry,” the POI extraction unit 34 extracts an ID of at least one of the POI from the POI information recording unit 52.

The POI extraction unit 34 extracts the ID of the POI whose distance from the current location of the user lies within a predetermined distance of X km. In this instance, it is assumed that the ID 001 and the ID 004 are extracted. Moreover, the POI extraction unit 34 may refer to the user-specific orientation recording unit 57, and extract the ID of the POI based on the orientation of the user.

Next, in step S6, from among pieces of the referral information recorded in the POI information recording unit 52 concerning the extracted POI (ID=001, 004), the referral text creation unit 32 creates the referral information including the related terms of the specific term that was set based on the input. In this instance, regarding the POI of ID 001, since the referral information “famous Indian curry restaurant” includes the related term “Indian curry” determined in the aforementioned step S4, the referral text creation unit 32 creates the referral text for the POI of ID 001 using the referral information “famous Indian curry restaurant”. Moreover, within the referral information concerning the POI of ID 001, since the text “using turmeric powder made in ◯◯,” does not include therein the related terms determined in step S4, the referral text creation unit 32 restricts the text “using turmeric powder made in ◯◯” from being used in the referral text. Further, regarding the POI of ID 004, since the referral information “famous vegetable curry restaurant” includes therein the related term “vegetable curry” determined in the aforementioned step S4, the referral text creation unit 32 creates the referral text for the POI of ID 004 using the referral information “famous vegetable curry restaurant”. Moreover, regarding the POI of ID 004, since the related term “potatoes” determined in the aforementioned step S4 is included within the referral information “using ◯◯ potatoes grown in ◯◯,” the referral text creation unit 32 may create the referral text for the POI of ID 004 using the referral information “using ◯◯ potatoes grown in ◯◯.” In the case that two or more of the referral information are capable of being used for one POI as in the present example, the referral text creation unit 32 may create the referral text by using the plurality of referral information, or by referring to the user-specific orientation recording unit 57 and using the referral information of the type preferred by the user (for example, “specialties”) with priority over other types of referral information (for example, “subcategories”) based on the orientation of the user.

The referral text creation unit 32, for example, creates the text “a famous Indian curry restaurant is located nearby,” and the text “a famous restaurant serving vegetable curry using ◯◯ potatoes grown in ◯◯ is located nearby.” Further, using addresses within the extracted POI identification information and the current position of the vehicle 16, the text “a famous Indian curry restaurant is located ◯◯ km up ahead along the road,” and the text “a famous restaurant serving vegetable curry using ◯◯ potatoes grown in ◯◯ is located ◯◯ km up ahead along the road” may be created.

Next, in step S7, data of the information (image information and voice information), which includes the referral text created by the referral text creation unit 32, is transmitted to the output device 24 and the display device 26 via the communication unit 60, the network 14, and the communication unit 22.

Consequently, in step S7, the positions of the “famous Indian curry restaurant” and the “famous vegetable curry restaurant” are displayed as POI on the map of the display device 26, together with an audio output being provided from the output device 24 including statements such as “a famous Indian curry restaurant is located nearby,” and “a famous restaurant serving vegetable curry using ◯◯ potatoes grown in ◯◯ is located nearby.”

In step S8, the referral text creation unit 32, which has detected an OK input from the user who selects any of the POI (step S8: YES), uses the navigation unit 40 in step S9, whereby route guidance to the extracted POI (selected POI) is carried out.

Further, in step S8, in the case that an input of NG information (information indicating that referral POI are not selected) from the user such as a question “is there any other location?” is detected (step S8: NO), then based on the related terms already determined in step S4, in step S5, the ID of the POI is extracted from the POI information recording unit 52 (for example ID 006) under conditions that differ from the previous ones (for example, the distance from the current location of the user is a predetermined distance Y (>X) km), the referral text is created in step S6, and in step S7, the position of “a famous chicken curry restaurant” is displayed as a POI on the map of the display device 26, together with an output being provided from the output device 24 including the statement “a famous restaurant serving chicken curry using carrots grown in ◯◯ and local chicken raised in ◯◯ is located ◯◯ km up ahead along the road.” Moreover, in step S8, in the case that an input of NG information (information indicating that referral POI are not selected) from the user such as a question “is there any other location?” is detected, and further, in the case that, from among the POI extracted in the aforementioned step S5, there are POI that have not been output together with the referral text from the output device 24 or the display device 26, then regarding the POI that have not been output, the creation and the output of the referral text in the aforementioned step S6 and step S7 may be carried out.

### Inventions that can be Grasped from the Embodiment

A description will be given below concerning the inventions capable of being grasped from the above-described embodiment. Although in order to facilitate understanding, the reference numerals used in the embodiment are applied to the constituent elements, the constituent elements are not limited to those to which such reference numerals have been applied.

The information providing system (server 10) according to the present invention is characterized by the information providing system (server 10) comprising the points of interest (POI) information recording unit 52 in which the identification information of POI is recorded in association with the referral information of the POI, and the referral text creation unit 32 which creates the referral text concerning the POI by using the referral information associated with the POI, the information providing system further comprising the term recording unit 54 in which there is recorded the specific term, and the related terms having a predetermined logical relationship with the specific term, and the POI extraction unit 34 that extracts at least one of the POI from the POI information recording unit 52, in accordance with the specific term that is set based on an input from a user, wherein the referral text creation unit 32 creates the referral text of the extracted POI using, from among pieces of the referral information recorded in the POI information recording unit 52 concerning the extracted POI, the referral information that includes the related terms of the specific term that is set based on the input.

In accordance with such a configuration, from among the pieces of the referral information recorded in the POI information recording unit 52 concerning the POI extracted in accordance with the specific term which is set based on the input from the user, the referral information that includes related terms of the specific term is used to create referral text of the extracted POI. Therefore, it is possible to provide appropriate POI referral information in accordance with the specific term based on the input from the user.

In this case, the predetermined logical relationship with the specific term may include at least one of a relationship defined as subclasses of the specific term, and a relationship defined as constituent ingredients of the specific term.

In accordance with such a configuration, the POI referral text is created using the POI referral information, in which there is included at least one of a relationship defined as subclasses of the specific term and a relationship defined as constituent ingredients of the specific term, and therefore it is possible to provide more appropriate POI referral information in accordance with the specific term which is set based on the input from the user.

Further, the referral text creation unit 32 preferably creates the referral text preferentially using the referral information including the related terms having the predetermined logical relationship with the specific term.

Since the referral information including the related terms is highly related with the orientation of the user, it is possible to provide more appropriate POI referral information in accordance with the specific term which is set based on the input from the user.

Furthermore, there may be further provided the user-specific orientation recording unit 57 in which the orientation of the user is recorded in advance, and wherein the referral text creation unit 32 may refer to the user-specific orientation recording unit 57, and may determine the predetermined logical relationship based on the orientation recorded for the user who is identified.

In accordance with such a configuration, since the referral text creation unit 32 refers to the user-specific orientation recording unit 57 in which the orientation of the user has been recorded in advance, and the predetermined logical relationship is determined based on the orientation recorded for the user who is identified, it is possible to provide appropriate POI referral information in accordance with the orientation of the user who has set the specific term.

The present invention is not limited to the embodiment described above, and it is a matter of course that various modified or additional configurations could be adopted therein based on the disclosed content of the present specification.

For example, in the above-described embodiment, the information providing system is provided in the form of the server 10; however, the information providing system may also be provided in the form of the vehicle 16, by the vehicle 16 being allowed to possess the computation unit 30 and the recording unit 50 shown in FIG. 1. The information providing system may be constituted by the server 10 and the vehicle 16. The vehicle 16 may be a passenger vehicle such as a four-wheeled vehicle, a truck, a two-wheeled vehicle, or the like. Further, the information providing system may be a mobile terminal such as a smartphone that is carried by the user.

What is claimed is:

1. An information providing system comprising a points of interest (POI) information recording unit configured to record identification information of POI in association with referral information of the POI, and a referral text creation unit configured to create referral text concerning the POI by using the referral information associated with the POI, the information providing system further comprising:
a term recording unit configured to record a specific term, and related terms having a predetermined logical relationship with the specific term; and
a POI extraction unit configured to extract at least one of the POI from the POI information recording unit, in accordance with the specific term that is set based on an input from a user,
wherein the referral text creation unit creates the referral text of the extracted POI using, from among pieces of the referral information recorded in the POI information recording unit concerning the extracted POI, the referral information that includes the related terms of the specific term that is set based on the input.

2. The information providing system according to claim 1, wherein the predetermined logical relationship with the specific term includes at least one of a relationship defined as subclasses of the specific term, and a relationship defined as constituent ingredients of the specific term.

3. The information providing system according to claim 1, wherein the referral text creation unit creates the referral text preferentially using the referral information including the related terms having the predetermined logical relationship with the specific term.

4. The information providing system according to claim 3, further comprising a user-specific orientation recording unit configured to record an orientation of the user in advance,
wherein the referral text creation unit refers to the user-specific orientation recording unit, and determines the predetermined logical relationship based on an orientation recorded for the user who is identified.
